(19) United States
(12) Patent Application Publication
(10) Pub. No.: US 2004/0083229 A1
(43) Pub. Date: Apr. 29, 2004

(54) Apparatus and method for automatically grading and inputting grades to electronic gradebooks

(76) Inventor: Robert Austin Porter, Livermore, CA (US)

Correspondence Address: O'BANION & RITCHEY, Wells Fargo Center, Suite 1550, 400 Capitol Mall, Sacramento, CA, 95814, US

(21) Appl. No.: 10/609,114

(22) Filed: Jun. 27, 2003

Related U.S. Application Data
(63) Continuation-in-part of application No. 10/236,024, filed on Sep. 3, 2002.
(60) Provisional application No. 60/317,135, filed on Sep. 4, 2001.

(51) Int. Cl. G06F 17/00

(52) U.S. Cl. 707/103 Y

(57) ABSTRACT

A system and method for automatically grading and inputting grades to electronic gradebooks includes a digital camera connected to a computer. A document, e.g., a test, can be placed within the view of the digital camera. A grading/data label can be affixed to the document and includes input bubbles or handwritten indicia within designated areas that can be completed to indicate a student identification number, answers to an exam/test/quiz/etc., and/or a grade. The computer includes a program for locating the grading/data label and further locating the completed bubbles and/or handwritten indicia within the grading/data label. Information corresponding to the completed bubbles or handwritten indicia can then be automatically graded, if desired, and input to an electronic gradebook within or available to the computer.

### CROSS-REFERENCE TO RELATED APPLICATIONS

This application claims priority from U.S. provisional patent application serial No. 60/317,135 filed on Sep. 4, 2001 and is a Continuation-In-Part application claiming priority from U.S. original application Ser. No. 10/236,024 filed on Sep. 3, 2002, both of which are incorporated herein by reference.

### STATEMENT REGARDING FEDERALLY SPONSORED RESEARCH OR DEVELOPMENT

Not Applicable

### REFERENCE TO A COMPUTER PROGRAM APPENDIX

Not Applicable

### NOTICE OF MATERIAL SUBJECT TO COPYRIGHT PROTECTION

Not Applicable

### BACKGROUND OF THE INVENTION

1. Field of the Invention

The present pertains generally to electronic gradebooks, and more particularly to a computer-implemented method for grading and inputting grades to electronic gradebooks.

2. Description of the Background Art

Along with preparing and teaching classroom lessons, teachers must grade students' assignments and record those grades in a gradebook. Gradebooks are essential in order to keep students accountable, track student progress, and determine students' final grades. Until recent years, most teachers used paper gradebooks and manually graded exams/tests/quizzes and manually calculated their students' grades. However, since computers have become ubiquitous, electronic gradebooks have also become extremely popular and the time-intensive task of calculating and tracking intermediate and final grades has been automated.

It happens that electronic gradebooks do more than simplify the job of calculating students' grades. The gradebooks allow teachers to sort information on students' progress and manipulate that information in ways too time consuming to do manually. For example, many electronic gradebooks allow teachers to input scores as numbers, symbols, or words and customize grades using scales, rounding, categories, and weighting. These technological advances have provided teachers with new ways to analyze student's performance and more efficient means to report progress to the students and their parents. These capabilities make electronic gradebooks tremendous tools for educators.

Although electronic gradebooks have proven to be invaluable for sorting, calculating, and reporting student progress, the mundane, time consuming task of entering the grades into the electronic gradebook is not much different from a paper gradebook. Where teachers once hand logged grades and scores for each piece of paper completed by students into a paper gradebook, they must now manually enter those grades and scores into an electronic gradebook using an input device such as a computer keyboard. Since most teachers need to track approximately two hundred (200) to six hundred (600) assignments per week, the tasks of grading and/or recording/entering grades consumes a significant amount of time that could otherwise be spent on lesson plan preparation and other similar and related educational endeavors.

Accordingly, the present invention recognizes the need for a system and method for automatically grading exams and quizzes and/or automatically inputting grades to an electronic gradebook. The present invention satisfies those needs, as well as others, and overcomes deficiencies with current approaches.

### BRIEF SUMMARY OF THE INVENTION

A system for automatically grading educational materials such as quizzes and exams and/or automatically inputting grades into an electronic gradebook includes a document having a data rectangle established on the surface thereof. Further, the system includes a digital camera and a microprocessor connected to the digital camera.

The microprocessor receives images from the digital camera, one at a time, and includes a program for either or both automatically grading and automatically inputting data from the data rectangle to an electronic gradebook. Preferably, the data rectangle is a grading label that includes (depending on whether the process of grading is included in the subject process or simply imputing a previously determined grade is desired): student answers, grade information, and student identification information.

One aspect of the grading label includes an identification number input area and a grade input area. In this aspect, the identification number input area includes a first row of numbered input bubbles, a second row of numbered input bubbles, and a third row of numbered input bubbles. It can be appreciated that the identification area of the grading label can have more than three rows of numbered input bubbles. Each row of numbered input bubbles further includes ten input bubbles and each bubble is individually and non-repeatingly numbered from zero to nine. In this aspect the grade input area includes a row of lettered input bubbles and a row of symbolled input bubbles. The row of lettered input bubbles includes five input bubbles and each input bubble is individually and non-repeatingly lettered with an A, B, C, D, or F. Moreover, the row of symbolled input bubbles includes three input bubbles and each symbolled input bubble is individually and non-repeatingly symbolled with a “√” (check), a “+” (plus), and a “−” (minus).

Another aspect of the grading label includes an identification number input area and a score input area. The identification number input area includes a first row of numbered input bubbles, a second row of numbered input bubbles, and a third row of numbered input bubbles. Each row of numbered input bubbles includes ten input bubbles that are individually and non-repeatingly numbered from zero to nine. The score input area includes a first row of numbered input bubbles and a second row of numbered input bubbles. Each row of numbered input bubbles within the score input area includes ten input bubbles that are individually numbered from zero to nine.

Still another aspect of the grading label includes a hand-written identification number input area and a hand-written score input area. The identification number input area includes a first plurality of computer recognizable “boxed” regions, one boxed region for each hand-written digit of a student identification number. The score input area includes a second plurality of computer recognizable boxed regions, one boxed region for each hand-written digit of a student's score.

Yet another aspect of the grading label includes an identification number input area and an answer input area. The identification number input area includes a first row of numbered input bubbles, a second row of numbered input bubbles, and a third row of numbered input bubbles. Each row of numbered input bubbles includes ten input bubbles that are individually and non-repeatingly numbered from zero to nine. The answer input area includes a plurality of numbered rows, wherein each numbered row contains a set of labeled answer input bubbles.

Yet still a further aspect of the grading label includes a hand-written identification number input area and a hand-written answer input area. The hand-written identification number input area includes a first plurality of computer recognizable “boxed” regions, one boxed region for each hand-written digit of a student identification number. The hand-written answer input area includes a second plurality of computer recognizable boxed regions, one boxed region for each hand-written answer.

In a preferred embodiment, the program within the microprocessor includes logic means for reading an image of the document, logic means for finding the data rectangle, logic means for grading (establishing the validity of each student provided answer based on an accepted/correct answer) the answers provided in the data rectangle, and logic means for inputting identification information and grade information from the data rectangle to the electronic gradebook. Further, the program includes logic means for finding completed input bubbles or hand-written indicia within the data rectangle and logic means for inputting information corresponding to the completed input bubbles or hand-written indicia to the electronic gradebook.

In another aspect of the present invention, a system for automatically grading and/or automatically inputting grades into an electronic gradebook includes a document and a data rectangle on the surface of the document. The data rectangle includes means for allowing a user to indicate an identification number and either answers to questions or a grade by either shading a series of input bubbles or placing hand-written indicia in designated locations. The system also includes a digital camera and a microprocessor connected to the digital camera. The microprocessor receives images from the digital camera and includes means for automatically grading and/or inputting data corresponding to shaded input bubbles or hand-written indicia in designated locations to an electronic gradebook.

In yet another aspect of the present invention, a method for automatically grading and/or automatically inputting data from a data rectangle to an electronic gradebook includes reading an image of a document having a data rectangle and automatically finding the data rectangle. Identification information and grading/score information is automatically input from the data rectangle to the electronic gradebook.

In still another aspect of the present invention, a method for grading student exams includes establishing a data rectangle on a document. The data rectangle includes either a plural input bubbles or a plurality of boxed regions for hand-written indicia. The method includes either completing one or more input bubbles or one or more boxed regions. The document is scanned with a digital camera. Data corresponding to either the completed input bubbles or boxed handwritten regions is automatically noted, graded, if needed, and input to an electronic gradebook.

An object of the invention is to provide educators with a means by which testing instruments can be automatically graded, if desired, and/or a score input to electronic gradebooks.

Another object of the invention is to minimize the time required to grade exams/quizzes and/or to input grades to electronic gradebooks.

Further objects and advantages of the invention will be brought out in the following portions of the specification, wherein the detailed description is for the purpose of fully disclosing preferred embodiments of the invention without placing limitations thereon.

### BRIEF DESCRIPTION OF THE DRAWINGS

The invention will be more fully understood by reference to the following drawings which are for illustrative purposes only:

FIG. 1 is a view the system architecture according to the present invention.

FIG. 2 is a plan view of a first embodiment of a data label according to the present invention.

FIG. 3 is a plan view of a second embodiment of a data label according to the present invention.

FIG. 4 is a flow chart of the overall operating logic for one embodiment of the present invention.

FIG. 5 is a flow chart of the rectangle finding logic according to the present invention.

FIG. 6 is a flow chart of the dithering logic according to the present invention.

FIG. 7 is a flow chart of the rectangle corner scoring logic according to the present invention.

FIG. 8 is a flow chart of the rectangle measuring logic according to the present invention.

FIG. 9 is a flow chart of the vertical line finding logic according to the present invention.

FIG. 10 is a flow chart of the horizontal line finding logic according to the present invention.

FIG. 11 is a flow chart of the vertical line scoring logic according to the present invention.

FIG. 12 is a flow chart of the horizontal line scoring logic according to the present invention.

FIG. 13 is a flow chart of the vertical angle finding logic according to the present invention.

FIG. 14 is a flow chart of the horizontal angle finding logic according to the present invention.

FIG. 15 is a flow chart of the rectangle scoring logic according to the present invention.

FIG. 16 is a flow chart of the marked bubble determining logic according to the present invention.

FIG. 17 is a flow chart of the bubble scoring logic according to the present invention.

FIG. 18 is a flow chart of the overall operating logic for a second embodiment of the present invention.

FIG. 19 is a plan view of a third embodiment of a data label according to the present invention in which both student identification information and student answers are entered in bubble regions.

FIG. 20 is a plan view of a fourth embodiment of a data label according to the present invention in which student identification information and a student score are entered in hand-written indicia.

FIG. 21 is a plan view of a fifth embodiment of a data label according to the present invention in which student identification information and student answers are entered in hand-written indicia.

### DETAILED DESCRIPTION OF THE INVENTION

Referring more specifically to the drawings, for illustrative purposes the present invention is embodied in the system and method described herein. It will be appreciated, however, that the system and method may vary without departing from the basic concepts as disclosed herein.

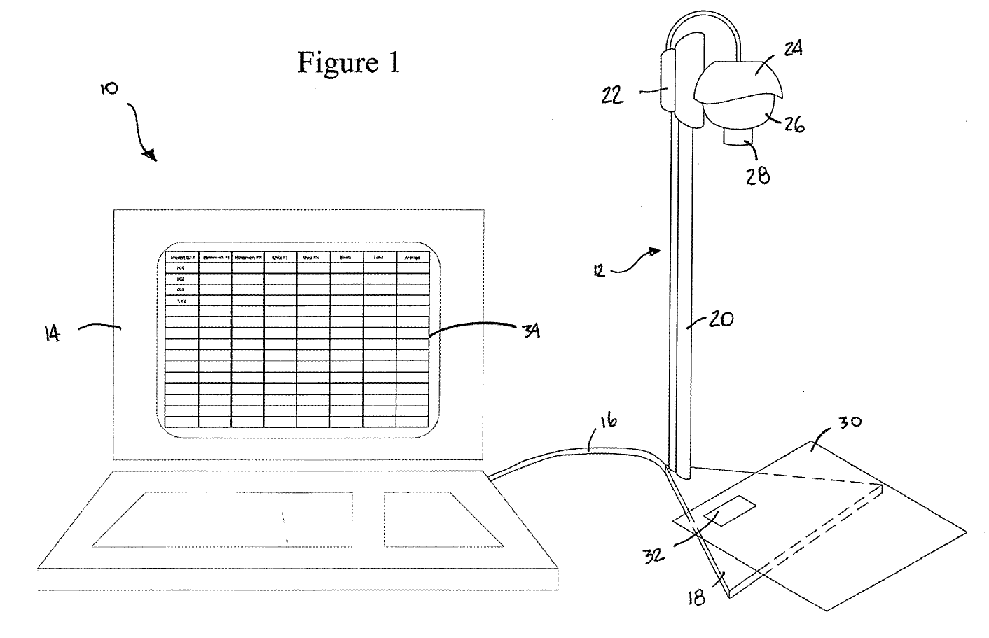

The present invention comprises a computer-implemented system and method for enabling an educator, e.g., a school teacher, to automatically grade and/or input grades to an electronic gradebook. As shown in FIG. 1, a system for automatically grading and/or inputting grades to an electronic gradebook is shown and is generally designated 10. FIG. 1 shows that the system 10 includes a digital camera 12 connected to a computer 14 via cord 16. In a preferred embodiment, the camera 12 utilizes complementary metal-oxide semiconductor (CMOS) technology, charge-coupled device (CCD) technology, or any other type of similar technology well known in the art. Moreover, the cord 16 is preferably connected to the computer 14 using a universal serial bus (USB) connector and the camera 12 provides a continuous scan to the computer 14.

FIG. 1 further shows that the camera 12 includes a base 18 from which a column 20 extends perpendicularly. A camera support collar 22 fits over the end of the column 20 so that the support collar 22 is distanced from the base 18. Moreover, a camera housing 24 is attached to the support collar 22. As shown in FIG. 1, a camera 26 is installed within the camera housing 24 and includes a lens assembly 28 that is directed down towards the base 18. Thus, a document 30, e.g., a student test paper, can be placed on the base 18, as shown, and the camera 26 can obtain an image of the document 30 and transmit the image to the computer 14. FIG. 1 shows that the document 30 can include a label 32, e.g., a grading label, described below, that can be used to record information regarding the document 30.

As shown in FIG. 1, the computer 14 can include an electronic gradebook 34 in which grade information can be input. FIG. 1 shows the gradebook 34 in the form of a spreadsheet. It can be appreciated that information regarding students, e.g., identification (ID) numbers, may be input to the electronic gradebook 34. Moreover, information regarding individual assignments, quizzes, exams, etc. may be input to the electronic gradebook 34. The electronic gradebook can be used manipulate the information input thereto, e.g., to keep a running total and determine an average.

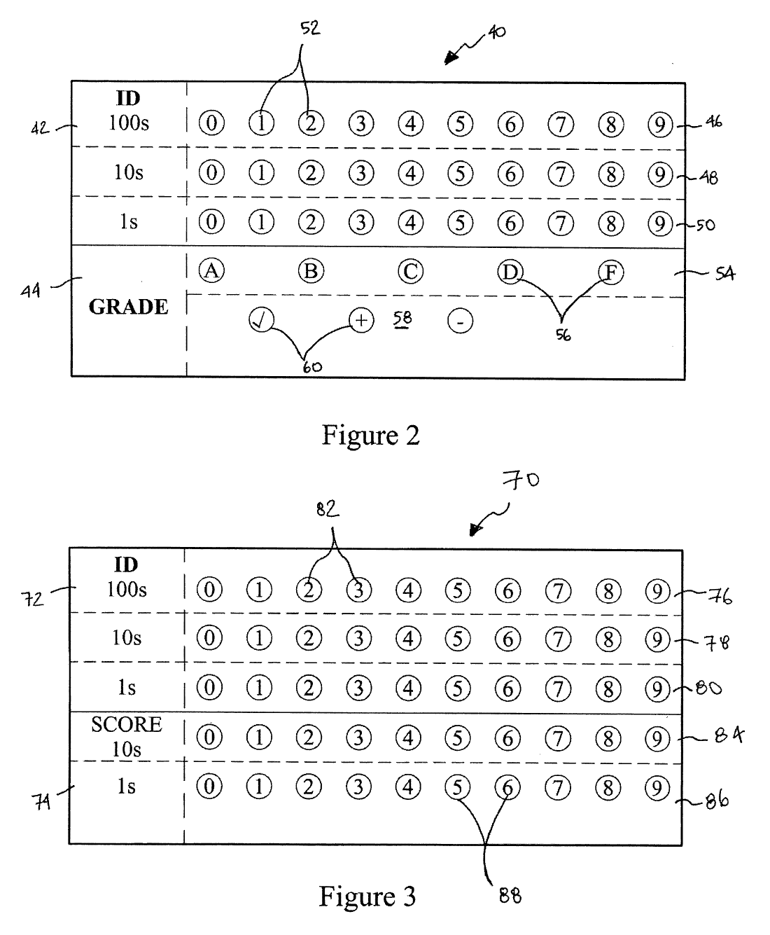

Referring to FIG. 2, a first exemplary grading/data label is shown an generally designated 40. FIG. 2 shows that the grading label 40 includes an ID number input area 42 and a grade input area 44. As shown, the ID number input area 42 includes a first row of numbered input bubbles 46, a second row of numbered input bubbles 48, and a third row of numbered input bubbles 50. In a preferred embodiment, each row of numbered input bubbles 46, 48, 50 includes ten individual bubbles 52 that are individually and non-repeatingly numbered from zero (0) to nine (9). As shown, the first row of numbered input bubbles 46 can be used to record the first digit of a three digit identification (ID) number, i.e., the digit in the hundreds place. Further, the second row of numbered input bubbles 48 can be used to record the second digit of a three digit ID number, i.e., the digit in the tens place. And, the third row of numbered input bubbles 50 can be used to record the third digit of a three digit ID number, i.e., the digit in the ones place. Thus, a student's three digit ID number can be recorded within the ID number input area 42 of the grading label 40. It can be appreciated that the ID number input area 42 of the grading label 40 can have more than three rows of numbered input bubbles, e.g., if four digit identification numbers were used for the students.

FIG. 2 shows that the grade input area 44 of the grading/data label 40 can include a row of lettered input bubbles 54 that includes five individual bubbles 56 each representing a letter grade, e.g., A, B, C, D, or F. Also, the grade input area 44 can include a row of symbolled input bubbles 58. As shown, the row of symbolled input bubbles 58 can include three individual bubbles 60, each having a different grade symbol, e.g., a “√” (check), a “+” (plus), or a “−” (minus). Thus, a student's letter grade, and any adjustment thereto, e.g., a “B−” (B minus), can be recorded within the grade input area 44 of the grading label 40. In the alternative, a simple “√” (check) can be recorded in order to note the completion of a particular assignment.

FIG. 3 shows a second exemplary grading/data label, generally designated 70. As shown, the grading label 70 can include an ID number input area 72 and a score input area 74. The ID number input area 72 includes a first row of numbered input bubbles 76, a second row of numbered input bubbles 78, and a third row of numbered input bubbles 80. Each row of numbered input bubbles 76, 78, 80 can include ten individual bubbles 82 that are individually and non-repeatingly numbered from zero (0) to nine (9). As shown, the first row of numbered input bubbles 76 can be used to record the first digit of a three digit identification (ID) number, i.e., the digit in the hundreds place. Further, the second row of numbered input bubbles 78 can be used to record the second digit of a three digit ID number, i.e., the digit in the tens place. The third row of numbered input bubbles 80 can be used to record the third digit of a three digit ID number, i.e., the digit in the ones place. Accordingly, a student's three digit ID number can be recorded within the ID number input area 72 of the grading label 70. It can be appreciated that the ID number input area 72 of the grading label 70 can have more than three rows of numbered input bubbles, e.g., if four digit identification numbers were used for the students.

As shown in FIG. 3, the score input area 74 of the grading/data label 70 can include a first row of numbered input bubbles 84 and a second row of numbered input bubbles 86. FIG. 3 shows that each row of numbered input bubbles 84, 86 within the score input area 74 of the grading/data label can include ten individual bubbles 88 that are individually numbered from zero (0) to nine (9). As shown, the first row of numbered input bubbles 84 can be used to record the first digit of a two digit test score, i.e., the digit in the tens place. Also, the second row of numbered input bubbles 86 can be used to record the second digit of a two digit test score, i.e., the digit in the ones place. Accordingly, a student's score on an exam, test, quiz, paper, homework assignment, etc. can be recorded within the score input area 74 of the grading label 70. It is to be understood that in this case the score can be from zero (0) to ninety-nine (99). However, it can be appreciated that the score input area 74 of the grading/data label 70 can have more than two rows of numbered input bubbles, e.g., if three digit grades are used.

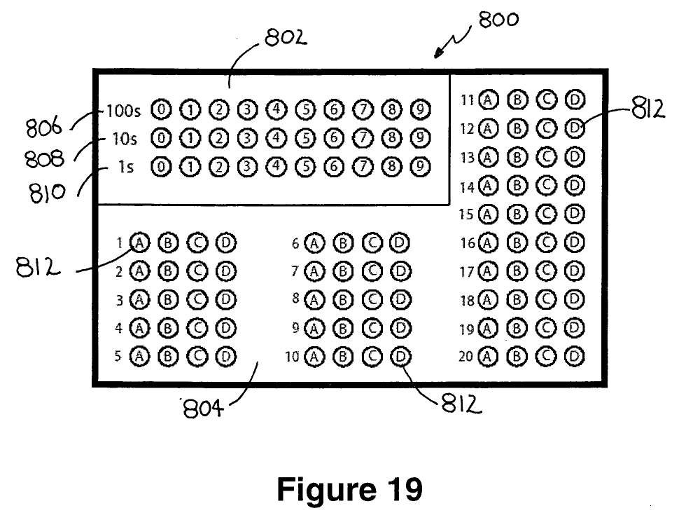

It can be appreciated that either embodiment of the grading/data label 40, 70 (and the three additional grading/data labels 800, 900, and 1000 seen in FIGS. 19, 20, and 21, respectively, and discussed in detail below) can include an adhesive backing so that the label 40, 70 can be affixed to a document, e.g., a quiz, test, exam, term paper, homework assignment, etc. In the alternative, either grading/data label 40, 70 can be established in inverse on the surface of an ink stamp, e.g., a rubber ink stamp, so that it can be stamped on the surface of the document.

It is to be understood that each embodiment of the grading/data label 40, 70 (and the three additional grading/data labels 800, 900, and 1000 seen in FIGS. 19, 20, and 21, respectively, and discussed in detail below) can be used in conjunction with a series of computer-executable instructions, as described below, that can enabling an educator to automatically grade and/or input grades into an electronic gradebook. The computer-executable instructions may be contained within the computer 14, e.g., in random access memory (RAM) within the computer 14 or on a data storage device with a computer readable medium, such as a computer diskette. Moreover, the instructions may be stored on a magnetic tape, conventional hard disk drive, electronic read-only memory (ROM), optical storage device, or other appropriate data storage device or transmitting device thereby making a computer program product, i.e., an article of manufacture according to the invention. In an illustrative embodiment of the invention, the computer-executable instructions may be written, e.g., using C++.

The flow charts herein illustrate the structure of the logic of the present invention as embodied in computer program software. Those skilled in the art will appreciate that the flow charts illustrate the structures of computer program code elements including logic circuits on an integrated circuit, that function according to this invention. Manifestly, the invention is practiced in its essential embodiment by a machine component that renders the program elements in a form that instructs a digital processing apparatus (that is, a computer) to perform a sequence of function steps corresponding to those shown.

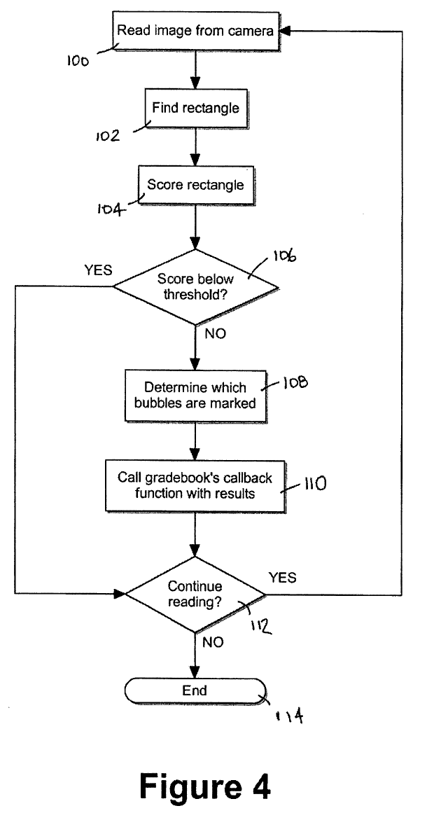

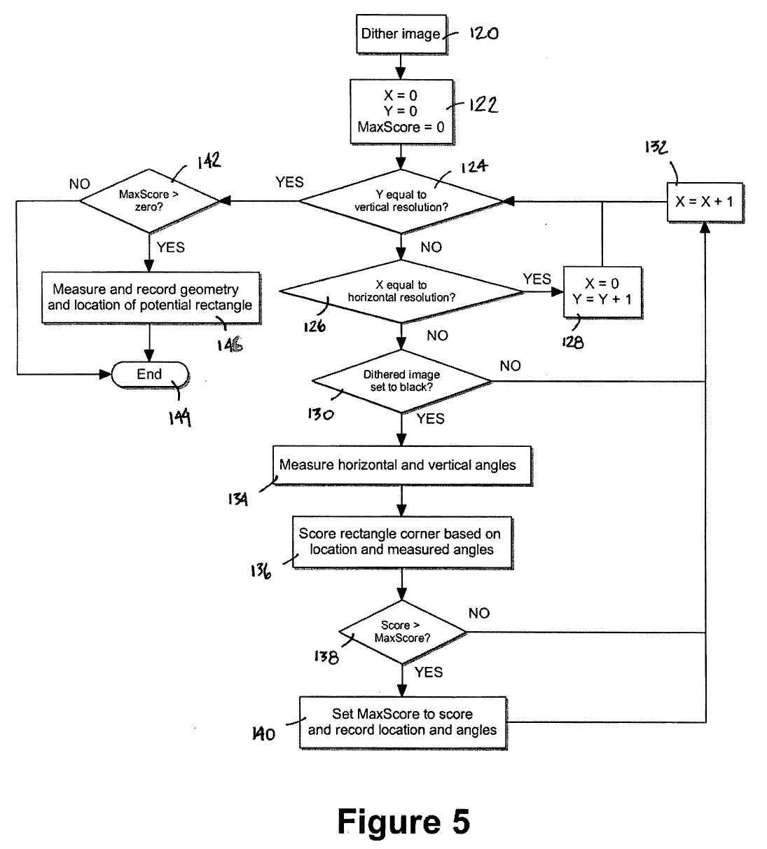

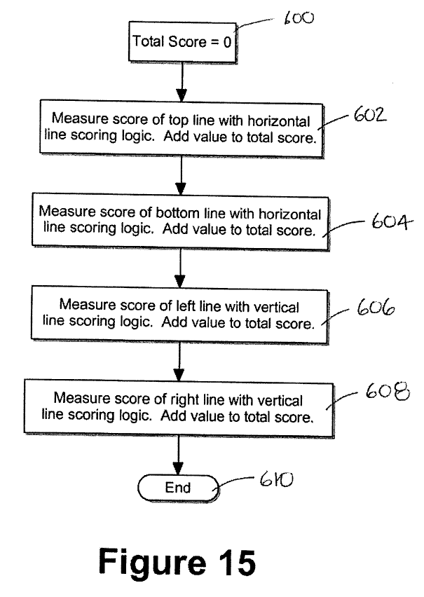

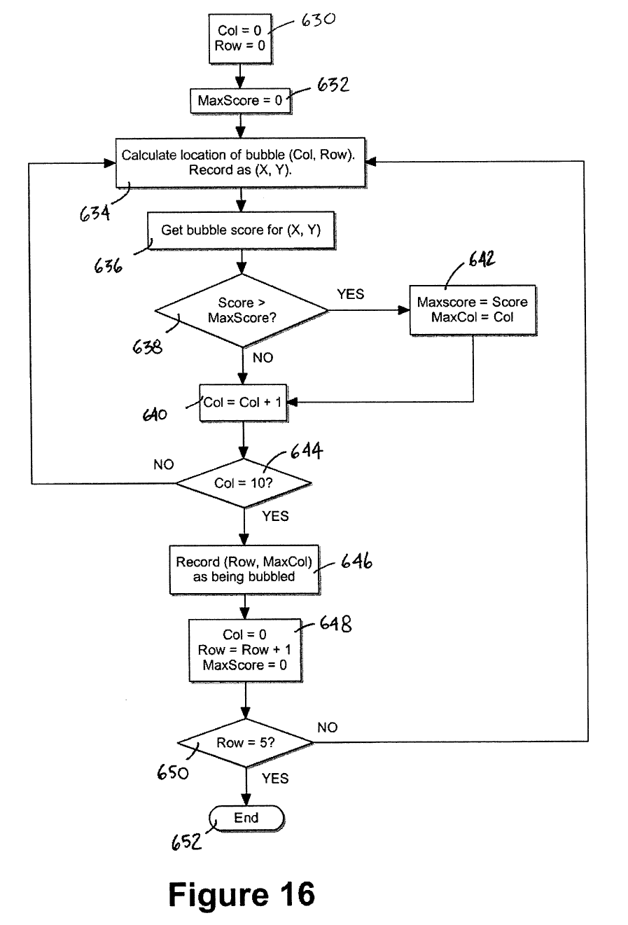

Referring to FIG. 4, the operating logic of the present invention is shown and commences at block 100, wherein an image is read from the camera 12. At block 102, a data rectangle, representing the outer border of the grading label 40, 70 is preferably found using the logic described below in conjunction with FIG. 5 through FIG. 14. Moving to block 104, the rectangle is scored, as described in detail below in conjunction with FIG. 15. It is to be understood that the scoring process is used to determine the intensity or darkness of what is potentially the outer perimeter of the data rectangle. Next, at decision diamond 106, it is determined whether the score is below a threshold value. If not, the logic proceeds to block 108 where it is determined which bubbles are marked. In a preferred embodiment that determination is undertaken using the marked bubble determining logic shown in FIG. 16, described below. Continuing to block 110, an electronic gradebook's call back function is called with the results of the determination in block 108. Next, at decision diamond 112, it is determined whether to continue reading images from the camera 12. If not, the logic ends at state 114. If so, the logic returns to 100 and another image is read from the camera 100. Returning to decision diamond 106, if the score is below the predetermined threshold, the logic proceeds to decision diamond 112. The logic then continues as described above. Accordingly, data corresponding to marked bubbles within the data rectangle can be automatically input to the electronic gradebook. This data can include ID numbers, letter grades, number scores, or symbol grades.

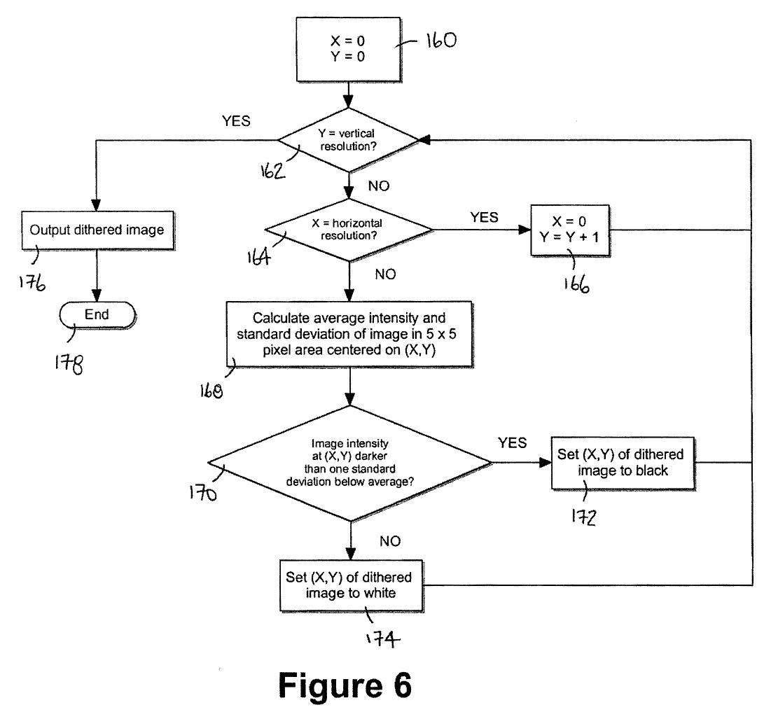

FIG. 5 shows the rectangle finding logic. In general, the rectangle finding logic inputs a grayscale image and if a data rectangle, e.g., the grading label 40, 70 described above, is found the logic outputs the geometry and location of the data rectangle. As shown in FIG. 5, the rectangle finding logic commences at block 120 wherein the image read above in FIG. 4 is dithered. In a preferred embodiment, the image is dithered using the logic shown in FIG. 6. Proceeding to block 122, an X variable is set equal to zero, a Y variable is set equal to zero, and a MaxScore variable is set equal to zero. At decision diamond 124, it is determined if Y is equal to vertical resolution. If not, the logic moves to decision diamond 126 where it is determined if X is equal to horizontal resolution. If so, the logic moves to block 128 where X is set equal to zero and Y is increased by one integer. The logic then returns to decision diamond 124, described above.

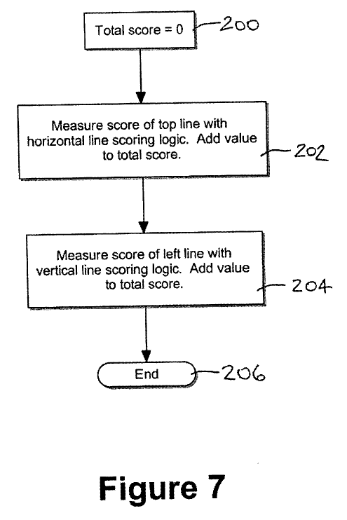

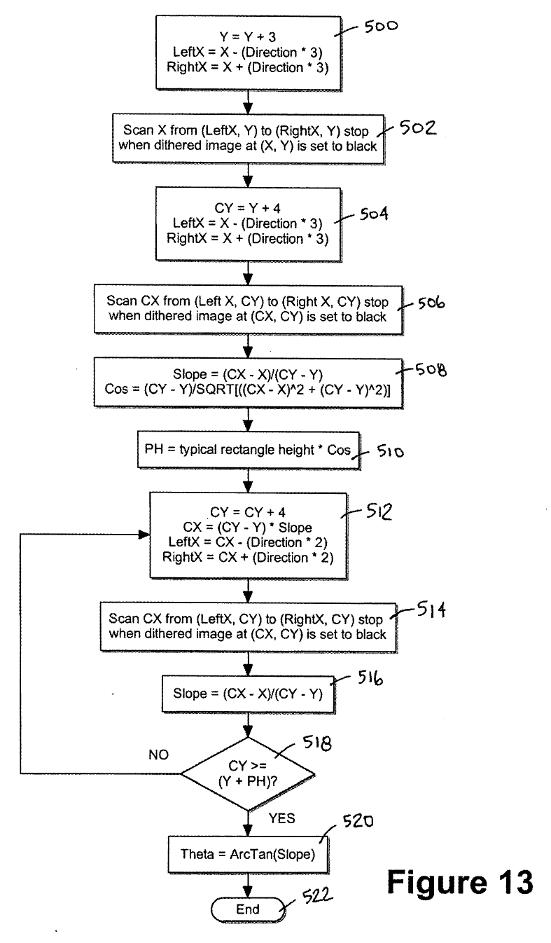

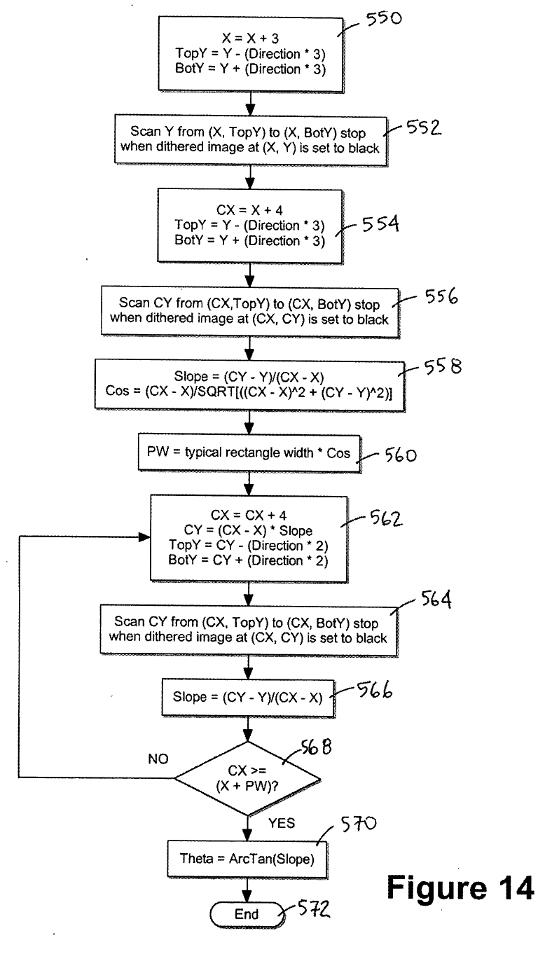

Returning to decision diamond 126, if X is not equal to horizontal resolution, the logic moves to decision diamond 130 where it is determined whether the dithered image is set to black. If not, the logic continues to block 132 where X is increased by one integer. If the dithered image is indeed set to black, the logic moves to block 134 where the vertical and horizontal angles are measured, preferably by using the vertical angle finding logic (FIG. 13) and horizontal angle finding logic (FIG. 14) described below. It is to be understood that the vertical and horizontal angles represent the angle at which the data rectangle is rotated with respect to a set coordinate system. Next, the rectangle corners are scored at block 136 based on location and measured angles. In a preferred embodiment, the rectangle corners are scored using the logic shown in FIG. 7.

Moving to decision diamond 138, it is determined whether the score is greater than MaxScore. If not, the logic returns to block 132 and continues as described above. On the other hand, at decision diamond 138, if the score is greater than MaxScore, the logic continues to block 140. At block 140, MaxScore is set equal to the score and the location of the corners and angles are stored. The logic then returns to block 132 and continues as described above.

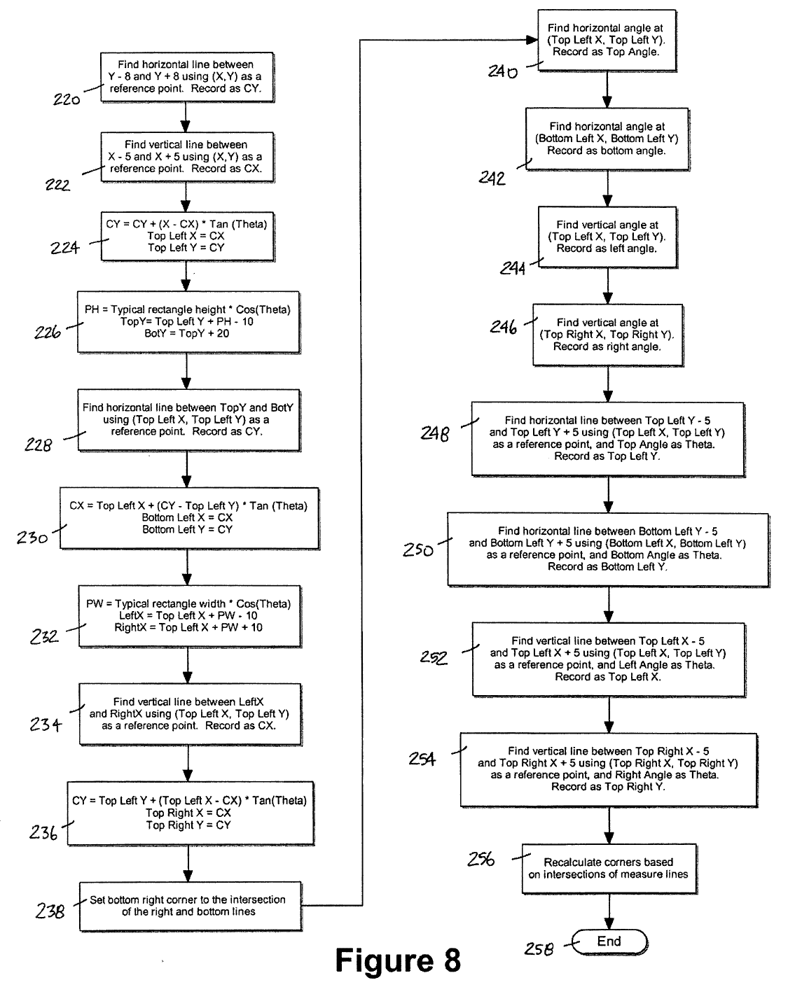

Returning to decision diamond 124, if Y is equal to vertical resolution, the logic moves to decision diamond 142 where it is determined if MaxScore is greater than zero. If MaxScore is not greater than zero, the logic ends at state 144. If MaxScore is indeed greater than zero, the logic moves to block 146 where the geometry and location of a potential rectangle is measured and recorded. Preferably, the rectangle is measured using the logic described below and shown in FIG. 8. The logic then ends at state 144.

Referring now to FIG. 6, the dithering logic, used above in block 120, is shown. It is to be understood that the dithering logic can be used to input a grayscale image and output a black and white image. The preferred dithering logic commences at block 160 where X is set equal to zero (0) and Y is set equal to zero (0). Next, at decision diamond 162 it is determined whether Y is equal to the vertical resolution. If not, the logic moves to decision diamond 164 where it is determined whether X is equal to the horizontal resolution. If X is equal to the horizontal resolution, the logic proceeds to block 166 and X is set equal to zero and Y is increased by one integer.

On the other hand, if X is not equal to the horizontal resolution, the logic moves to block 168 where the average intensity and standard deviation of the image in a five-by-five (5×5) pixel area centered on (X, Y) is calculated. Continuing to decision diamond 170, it is determined whether the image intensity at (X, Y) is darker than one standard deviation below average. If so, (X, Y) of the dithered image is set to black at block 172. The logic then returns to decision diamond 162 and continues as described above. At decision diamond 170, if the image intensity at (X, Y) is not darker than one standard deviation below average, the logic moves to block 174 and (X, Y) of the dithered image is set to white. The logic then returns to decision diamond 162 and continues as described above. At decision diamond 162, if Y is equal to the vertical resolution, the logic moves to block 176 and a dithered image is output. The logic then ends at state 178.

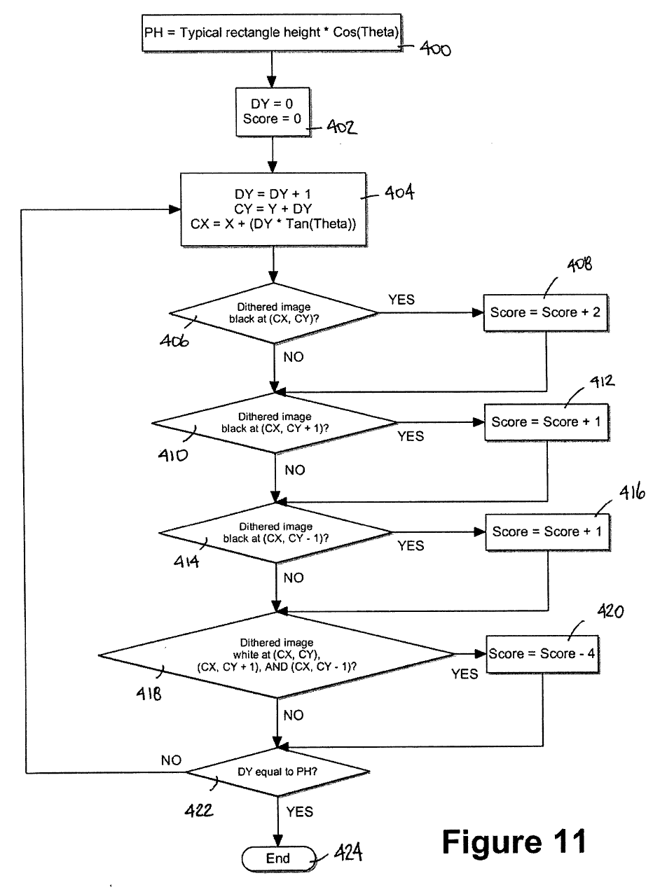

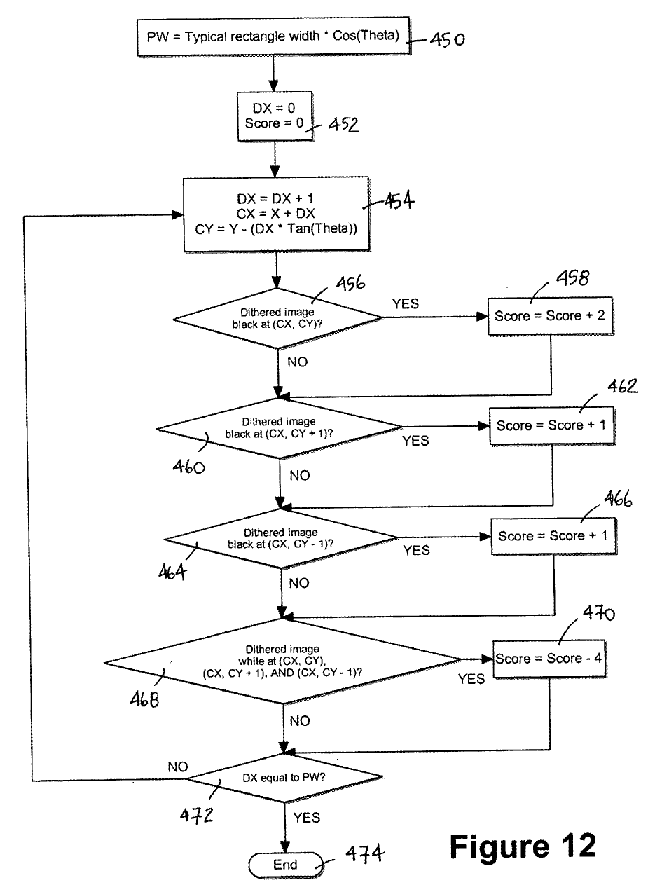

FIG. 7 shows the rectangle corner scoring logic used above in block 136 of FIG. 5. The rectangle corner scoring logic commences at block 200 where the total score is set equal to zero (0). At block 202, the score of the top line is measured and that value is added to the total score. Preferably, the score of the top line is measured using the horizontal line scoring logic shown in FIG. 12, described below. Moving to block 204, the score of the left line is measured and that value is added to the total score. In a preferred embodiment, the score of the left line is measured using the vertical line scoring logic shown in FIG. 11, described below. The logic then ends at state 206. It is to be understood that the logic shown in FIG. 7 can be used to one or more corners of a potential rectangle and output a total score for that rectangle corner(s).

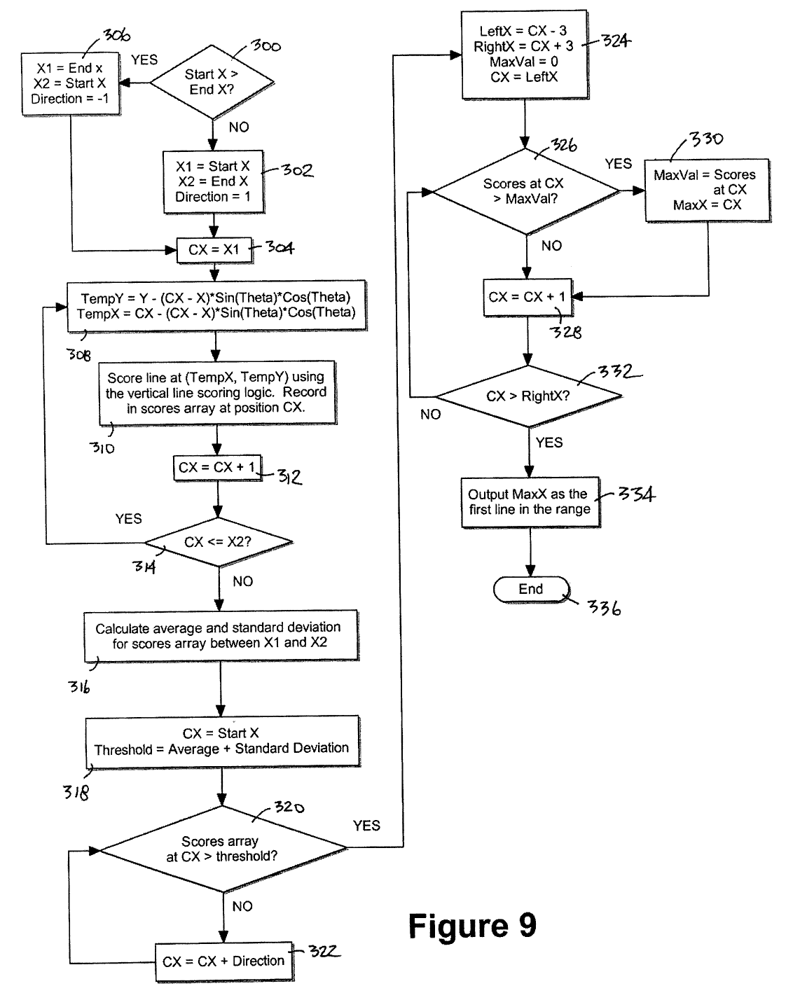

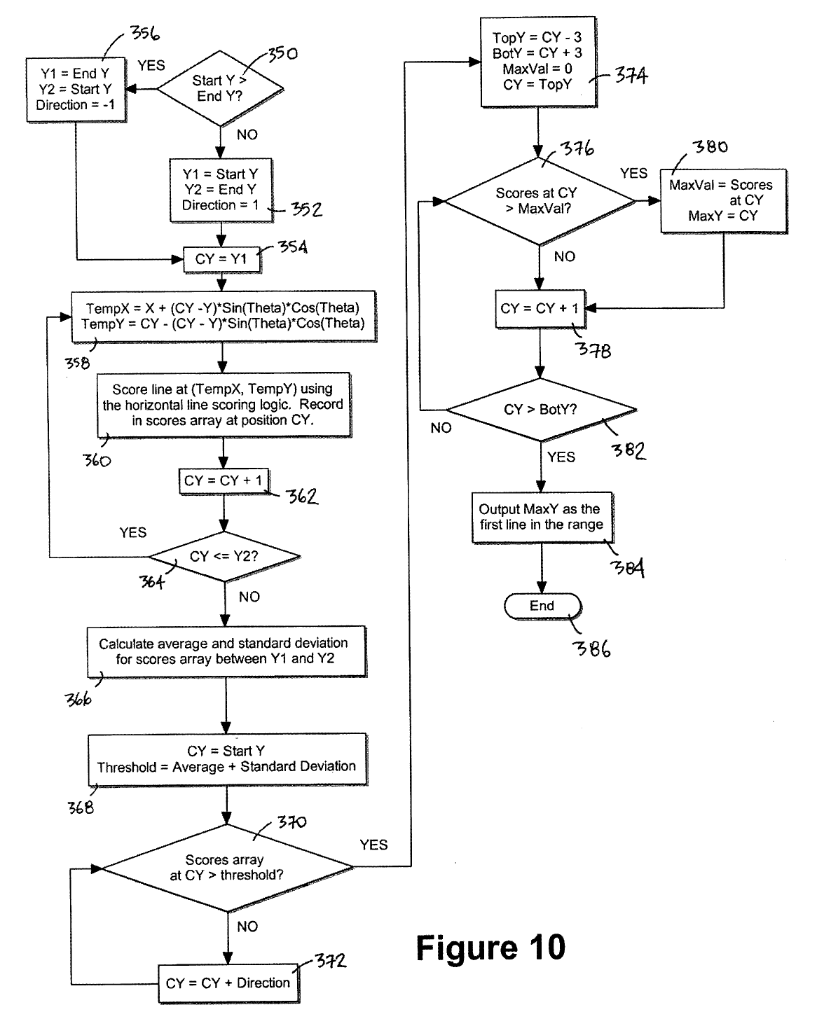

Referring to FIG. 8, the preferred rectangle measuring logic used above in block 146 of FIG. 5 is shown. In general, the rectangle measuring logic can be used to measure the geometry of a data rectangle. As shown, the rectangle measuring logic commences at block 220 wherein a horizontal line is found between Y−8 and Y+8 a reference point, e.g., (X, Y). This line is recorded as CY. Preferably, the horizontal line is found using the logic shown in FIG. 10, described below. At block 222, a vertical line is found between X−5 and X+5 using (X, Y) as a reference point. This line is recorded as CX. In a preferred embodiment, this line is found using the vertical line finding logic shown in FIG. 9, described below. Moving to block 224, a variable, Top Left X, is set equal to CX; a variable Top Left Y is set equal to CY; and the value of CY is determined using the following formula:

CY=CY+(X−CX)* Tan(Theta)

It is to be understood that Theta is the angle of rotation of the data rectangle with respect to a fixed coordinate system, described above, and is preferably determined using vertical angle finding logic or the horizontal angle finding logic shown in FIG. 13 and FIG. 14, described below. Proceeding to block 226, three variables, PH, TopY, and BotY, are determined using the following formulas:

PH=TypicalReaangleHeight*Cos(Theta)

TopY=TopLeftY+PH−10

BotY=TopY+20

Where TypicalRectangleHeight is a predetermined value based on the size of the grading label 40, 70 described above. At block 228, a horizontal line is found between TopY and BotY using (Top Left X, Top Left Y) as a reference point. This line is recorded as CY. Next, at block 230, CX is re-determined using the formula:

CX=TopLeftX+(CY−TopLeftY)*Tan(Theta)

Moreover, at block 230, a variable, Bottom Left X, is set equal to CX; and a variable, Bottom Left Y, is set equal to CY. At block 232, three variables, PW, LeftX, and RightX, are determined using the following equations:

PW=TypicalRectangleWidth*Cos(Theta)

LeftX=TopLeftX+PW−10

RightX=TopLeftX+PW+10

Proceeding to block 234, a vertical line is found between Left X and Rightx using (TopLeftX, TopLeftY) as a reference point. This line is recorded as CX. At block 236, CY is re-determined using the following formula:

CY=TopLeftY+(TopLeftX−CX)*Tan(Theta)

Also, at block 236, Top Right X is set equal to CX and Top Right Y is set equal to CY. Continuing to block 238, the bottom right corner of the rectangle is set equal to the intersection of the right and bottom lines. At block 240, a horizontal angle is found at (Top Left X, Top Left Y) and recorded as Top Angle. Moving to block 242, a horizontal angle is found at (Bottom Left X, Bottom Left Y) and recorded as Bottom Angle. Preferably, these horizontal angles are found using the horizontal angle finding logic shown in FIG. 14. At blocks 244 and 246, vertical angles are found at (Top Left X, Top Left Y) and at (Top Right X, Top Right Y). These angles are recorded as Left Angle and Right Angle, respectively. In a preferred embodiment, these angles are found using the vertical angle finding logic shown in FIG. 13.

Proceeding to block 248, horizontal line is found between Top Left Y−5 and Top Left Y+5 using (Top Left X, Top Left Y) as a reference point, and Top Angle as Theta. This line is recorded as Top Left Y. Next, at block 250, a horizontal line is found between Bottom Left Y−5 and Bottom Left Y+5 using (Bottom Left X, Bottom Left Y) as a reference point, and Bottom Angle as Theta. This line is recorded at Bottom Left Y. It is to be understood that in a preferred embodiment, these lines are found using the logic shown in FIG. 10, described below.

At block 252, a vertical line is found between Top Left X−5 and Top Left X+5 using (Top Left X, Top Left Y) as a reference point, and Left Angle as Theta. This line is recorded as Top Left X. Further, moving to block 254, a vertical line is found between Top Right X−5 and Top Right X+5 using (Top Right X, Top Right Y) as a reference point, and Right Angle as Theta. This line is recorded as Top Right Y. Preferably, these lines are determined using the vertical line finding logic shown in FIG. 9. Continuing to block 256, the corners of the rectangle can be recalculated based on the intersections of the lines found above. The logic then ends at state 258.

FIG. 9 shows the vertical line finding logic referred to above. This logic is useful for finding the coordinates of the first actual line in a range of coordinates. The location of the line is determined based on an angle, e.g., Theta, and a reference location, e.g., (X, Y). As shown in FIG. 9, the logic commences at decision diamond 300 where it is determined if a Start X is greater than an End X. If not, the logic moves to block 302 wherein X1, a variable, is set equal to Start X and X2, a variable, is set equal to an End X. Direction, another variable, is set equal to one (1). Next, at block 304, CX is set equal to X1.

Returning to decision diamond 300, if the Start X is greater than the End X, the logic moves to block 306 and X1 is set equal to End X, X2 is set equal to Start X, and Direction is set equal to negative one (−1). From block 306, or block 304, the logic moves to block 308 where TempY and TempX are determined using the following formulas:

TempY=Y−(CX−X)*Sin(Theta)*Cos(Theta)

TempX=CX−(CX−X)*Sin(Theta)*Sin(Theta)

Proceeding to block 310, the line at (TempX, TempY) is scored, preferably, using the vertical line scoring logic shown in FIG. 11 and described below. This score is record in a scores array at position CX. Moving to block 312, CX is increased by one integer. Next, at decision diamond 314, it is determined if CX is less than or equal to X2. If so, the logic returns to block 308 and continues as described above. On the other hand, if CX is greater than X2, the logic continues to block 316 where an average and standard deviation are calculated for the scores array between X1 and X2.

Moving to block 318, CX is set equal to Start X and a threshold value is determined by adding the average and the standard deviation. At decision diamond 320, it is determined whether the scores array at CX is greater than the threshold value determined at block 318. If not, the logic moves to block 322 and CX is increased or decreased by one integer depending on the value of the Direction variable established above at block 302 or block 306. If, at decision diamond 320, the scores array at CX is greater than the threshold value, the logic proceeds to block 324 where LeftX is established as CX minus three (3), Rightx is established as CX plus three (3), and MaxVal is set equal to zero (0), and CX is re-established as LeftX.

Next, at decision diamond 326, it is determined whether the scores array at CX is greater than MaxVal. If not, CX is increased by one (1) integer at block 328. If the scores array at CX is indeed greater than MaxVal, the logic moves to block 330 where MaxVal is set equal to the scores array at CX and MaxX is established as CX. From block 328, the logic moves to decision diamond 332, where it is determined whether CX is greater than RightX. If not, the logic returns to decision diamond 326 and continues as described above. On the other hand, if CX is greater than Rightx, the logic moves to block 334 and MaxX is output as the first line in the range. The logic then ends at state 336.

FIG. 10 shows the horizontal line finding logic referred to above. Like the logic shown in FIG. 9, this logic is also useful for finding the coordinates of the first actual line in a range of coordinates. The location of the line is determined based on an angle, e.g., Theta, and a reference location, e.g., (X, Y). As shown in FIG. 10, the logic commences at decision diamond 350 where it is determined if a Start Y is greater than an End Y. If not, the logic moves to block 352 wherein Y1, a variable, is set equal to Start Y and Y2, a variable, is set equal to an End Y. Direction, another variable, is set equal to one (1). Next, at block 354, CY is set equal to Y1.

Returning to decision diamond 350, if the Start Y is greater than the End Y, the logic moves to block 356 and Y1 is set equal to End Y, Y2 is set equal to Start Y, and Direction is set equal to negative one (−1). From block 356, or block 354, the logic moves to block 358 where TempX and TempY are determined using the following formulas:

TempX=X+(CY−Y)*Sin(Theta)*Cos(Theta)

TempY=CY−(CY−Y)*Sin(Theta)*Sin(Theta)

Proceeding to block 360, the line at (TempX, TempY) is scored, preferably, using the horizontal line scoring logic shown in FIG. 12 and described below. This score is record in a scores array at position CY. Moving to block 362, CY is increased by one (1) integer. Next, at decision diamond 364, it is determined if CY is less than or equal to Y2. If so, the logic returns to block 358 and continues as described above. On the other hand, if CY is greater than Y2, the logic continues to block 366 where an average and standard deviation are calculated for the scores array between Y1 and Y2.

Moving to block 368, CY is set equal to Start Y and a threshold value is determined by adding the average and the standard deviation. At decision diamond 370, it is determined whether the scores array at CY is greater than the threshold value determined at block 368. If not, the logic moves to block 372 and CY is increased or decreased by one integer depending on the value of the Direction variable established above at block 352 or block 356. If, at decision diamond 370, the scores array at CY is greater than the threshold value, the logic proceeds to block 374 where TopY is established as CY minus three (3), BotY is established as CY plus three (3), and MaxVal is set equal to zero (0), and CY is re-established as TopY.

Next, at decision diamond 376, it is determined whether the scores array at CY is greater than MaxVal. If not, CY is increased by one (1) integer at block 378. If the scores array at CY is indeed greater than MaxVal, the logic moves to block 380 where MaxVal is set equal to the scores array at CY and MaxY is established as CY. From block 378, the logic moves to decision diamond 382, where it is determined whether CY is greater than BotY. If not, the logic returns to decision diamond 376 and continues as described above. On the other hand, if CY is greater than BotY, the logic moves to block 384 and MaxY is output as the first line in the range. The logic then ends at state 386.

Referring now to FIG. 11, the vertical line scoring logic is shown. It is to be understood that the vertical line scoring logic receives a dithered image, generated above, as well as the location, angle, and length of a potential line to be scored. Objects that most likely appear to be lines are assigned greater scores. The vertical line scoring logic commences at block 400 where PH is determined using the following equation:

PH=TypicalRectangleHeight*Cos(Theta)

Where, TypicalRectangleHeight is a predetermined value based on the size of the grading label 40, 70, described above. Moving to block 402, DY, a variable, is set equal to zero. A score value, Score, is also set equal to zero. At block 404, DY, CY, and CX are determined from the following formulae:

DY=DY+1

CY=Y+DY

CX=X+(DY*Tan(Theta))

At decision diamond 406, it is determined whether the dithered image is black at (CX, CY). If so, the score is increased by two (2) integers, at block 408. From block 408, or from decision diamond 406, if the dithered image is not black at (CX, CY), the logic proceeds to decision diamond 410 where it is determined whether the dithered image is black at (CX, CY+1). If so, the logic moves to block 412 where the score is increased by one (1) integer. From block 412, or from decision diamond 410, if the dithered image is not black at (CX, CY+1), the logic continues to decision diamond 414. At decision diamond 414, it is determined whether the dithered image is black at (CX, CY−1). If so, the logic moves to block 416 and the score is increased by one (1) integer.

From block 416, or from decision diamond 414, if the dithered image is not black at (CX, CY−1), the logic proceeds to decision diamond 418 where it is determined whether the dithered image is white at (CX, CY), (CX, CY+1) and (CX, CY−1). If so, the logic moves to block 420 where the score is decreased by four (4) integers. From block 420, or from decision diamond 418, if the dithered image is not white at (CX, CY), (CX, CY+1) and (CX, CY−1), the logic continues to decision diamond 422. At decision diamond 422, it is determined whether DY is equal to PH. If DY is not equal to PH, the logic returns to block 404 and continues as described above. If DY is equal to PH, the logic ends at state 424.

Referring now to FIG. 12, the horizontal line scoring logic is shown. It is to be understood that the horizontal line scoring logic receives a dithered image, generated above, as well as the location, angle, and length of a potential line to be scored. Objects that most likely appear to be lines are assigned greater scores. As shown, the horizontal line scoring logic commences at block 450 where PW is determined using the following equation:

PW=TypicalReaangleWidth*Cos(Theta)

Where, the TypicalRectangleWidth is a predetermined value based on the width of the grading label 40, 70, described above. Moving to block 452, DX, a variable, is set equal to zero. A score value, Score, is also set equal to zero. At block 454, DX, CX, and CY are determined from the following formulae:

DX=DX+1

CX=X+DX

CY=Y−(DX*Tan(Theta))

At decision diamond 456, it is determined whether the dithered image is black at (CX, CY). If so, the score is increased by two (2) integers, at block 458. From block 458, or from decision diamond 456, if the dithered image is not black at (CX, CY), the logic proceeds to decision diamond 460 where it is determined whether the dithered image is black at (CX, CY+1). If so, the logic moves to block 462 where the score is increased by one (1) integer. From block 462, or from decision diamond 460, if the dithered image is not black at (CX, CY+1), the logic continues to decision diamond 464. At decision diamond 464, it is determined whether the dithered image is black at (CX, CY−1). If so, the logic moves to block 466 and the score is increased by one (1) integer.

From block 466, or from decision diamond 464, if the dithered image is not black at (CX, CY−1), the logic proceeds to decision diamond 468 where it is determined whether the dithered image is white at (CX, CY), (CX, CY+1) and (CX, CY−1). If so, the logic moves to block 470 where the score is decreased by four (4) integers. From block 470, or from decision diamond 468, if the dithered image is not white at (CX, CY), (CX, CY+1) and (CX, CY−1), the logic continues to decision diamond 472. At decision diamond 472, it is determined whether DY is equal to PH. If DY is not equal to PH, the logic returns to block 454 and continues as described above. Otherwise, if DY is equal to PH, the logic ends at state 474.

Now, referring to FIG. 13, the vertical angle finding logic is shown. It is to be understood that the vertical angle finding logic can be used to measure the angle of a vertical line with respect to a reference line starting at a reference point, e.g., (X, Y). Commencing at block 500, Y is set equal to Y plus three and LeftX and Rightx are determined using the following equations:

LeftX=X−(Direction*3)

RightX=X+(Direction*3)

The variable Direction above is either one (1) or negative one (−1) depending on the direction in which the scan is to be conducted, i.e., left or right, respectively. At block 502, X is scanned from (LeftX, Y) to (RightX, Y). The scan is stopped when the dithered image at (X, Y) is set to black. Next, at block 504, CY is set equal to Y+4 and LeftX and Right X are determined as follows:

LeftX=X−(Direction*3)

RightX=X+(Direction*3)

Proceeding to block 506, CX is scanned from (LeftX, CY) to (Rightx, CY). The scan is stopped when the dithered image at (CX, CY) is set to black. Continuing to block 508, the slope and the cosine are determined using the following equations:

$$Slope = ( CX - X ) / ( CY - Y )$$

$$Cos = ( CY - Y ) \sqrt{{( CX - X )}^{2} + {( CY - Y )}^{2}}$$

Next, at block 510, PH is determined as follows:

PH=TypicalRectangleHeight*Cos

Where the TypicalRectangleHeight is a predetermined value based on the size of the grading label 40, 70, described above. Further, at block 512, CY, CX, LeftX, and RightX are determined using the following equations:

CY=CY+4

CX=(CY−Y)*Slope

LeftX=CX−(Direction*2)

RightX=CX+(Direction*2)

Then, at block 514, CX is scanned from (LeftX, CY) to (RightX, CY). The scan stops when the dithered image at (CX, CY) is set to black. Continuing to block 516, the slope is again determined using the equation:

Slope=(CX−X)/(CY−Y)

Moving to decision diamond 518, it is determined whether CY is greater than or equal to Y plus PH. If so the logic moves to block 520 where the angle, Theta, is determined as follows:

Theta=ArcTan(Slope)

From block 520, the logic ends at state 522. At decision diamond 518, if CY is less than Y plus PH, the logic returns to block 512 and continues as described above.

FIG. 14 shows the horizontal angle finding logic. It is to be understood that the horizontal angle finding logic can be used to measure the angle of a horizontal line with respect to a predetermined reference line starting at a reference point, e.g., (X, Y). Commencing at block 550, X is set equal to X plus three and TopY and BotY are determined using the following equations:

TopY=Y−(Direction*3)

BotY=Y+(Direction*3)

The variable Direction above is either one (1) or negative one (−1) depending on the direction in which the scan is to be conducted, i.e., left or right, respectively. At block 552, Y is scanned from (X, TopY) to (X, BotY). The scan is stopped when the dithered image at (X, Y) is set to black. Next, at block 554, CX is set equal to X+4 and TopY and BotY are determined as follows:

LeftX=X−(Direction*3)

RightX=X+(Direction*3)

Proceeding to block 556, CY is scanned from (CX, TopY) to (CX, BotY). The scan is stopped when the dithered image at (CX, CY) is set to black. Continuing to block 558, the slope and the cosine are determined using the following equations:

$$Slope = ( CY - Y ) / ( CX - X )$$

$$Cos = ( CX - X ) \sqrt{{( CX - X )}^{2} + {( CY - Y )}^{2}}$$

Next, at block 560, PW is determined as follows:

PW=TypicalRectangleWidth*Cos

Further, at block 562, CX, CY, TopY, and BotY are determined using the following equations:

CX=CX+4

CY=(CX−X)*Slope

TopY=CY−(Direction*2)

BotY=CY+(Direction*2)

Then, at block 564, CY is scanned from (CX, TopY) to (CX, BotY). The scan stops when the dithered image at (CX, CY) is set to black. Continuing to block 566, the slope is again determined using the equation:

Slope=(CY−Y)/(CX−X)

Moving to decision diamond 568, it is determined whether CX is greater than or equal to X plus PW. If so the logic moves to block 570 where the angle, Theta, is determined as follows:

Theta=ArcTan(Slope)

From block 570, the logic ends at state 572. At decision diamond 568, if CX is less than X plus PW, the logic returns to block 562 and continues as described above.

Referring to FIG. 15, the rectangle scoring logic is shown and commences at block 600 where a total score value is set equal to zero. At block 602, the score of the top line is measured and added to the total score. Moving to block 604, the score of the bottom line is measured and added to the total score. In a preferred embodiment, the horizontal line scoring logic shown in FIG. 12, described above, is used to measure the score of the top line and the bottom line. Continuing to block 606, the score of the left line is measured and added to the total score. At block 608, the score of the right line is measured and added to the total score. Preferably, the left line and the right line are scored using the vertical line scoring logic shown in FIG. 11 and described above. Accordingly, the rectangle scoring logic can be used to determine the pixel intensity or darkness of all four measured lines of a rectangle and record that intensity as a score. The dithered image and geometry of the rectangle is input thereto and a total score can be determined and output therefrom.

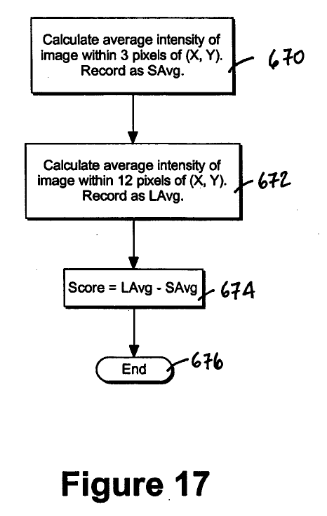

Referring now to FIG. 16, the marked bubble determining logic is shown. The marked bubble determining logic can be used to determine which bubbles a user, e.g., a student, marked with the data rectangle, e.g., the grading label 40, 70 described above. The geometry of the data rectangle and a grayscale image can be input to the logic shown in FIG. 16 and decoded values can be output therefrom. As shown in FIG. 16, the marked bubble determining logic commences at block 630, where a column value, Col, is set equal to zero (0). Also, at block 630, a row value, Row, is set equal to zero (0). Next, at block 632, a MaxScore value is set equal to zero (0). Moving to block 634, the location of a bubble (Col, Row) is calculated and recorded as (X, Y). Next, at block 636, a bubble score for (X, Y) is obtained using the bubbling scoring logic shown in FIG. 17, described below.

Continuing to decision diamond 638, it is determined whether the bubble score, Score, is greater than MaxScore. If not, Col is increased by one integer. If Score is indeed greater than MaxScore, the logic moves to block 642 where MaxScore is set equal to Score and a MaxCol value is set equal to Col. From block 642, the logic moves to block 640, described above, where Col is increased by one integer. The logic moves from block 640 to decision diamond 644.

At decision diamond 644, it is determined whether Col is equal to ten (10). If not, the logic returns to block 634 and continues as described above. If Col is equal to ten (10), the logic moves to block 646 where location (Row, MaxCol) is recorded as being bubbled. Thereafter, at block 648, Col is reset to zero, Row is increased by one (1) integer, and MaxScore is reset to zero (0). Continuing to decision diamond 650, it is determined whether Row is equal to five (5). If Row is not equal to five (5), the logic returns to block 634 and proceeds as described above. On the other hand, if Row is equal to five (5), the logic ends at state 652.

Referring now to FIG. 17, the bubble scoring logic is shown and commences at block 670 wherein the average intensity of the image within three pixels of (X, Y) is calculated and recorded as SAvg. At block 672, the average intensity of the image within 12 pixels of (X, Y) is calculated and recorded as LAvg. Moving to block 674, the bubble score is determined using the following formula:

Score=LAvg−SAvg

After the bubble score is determined, the logic ends at state 676. It is to be understood that the bubble scoring logic can be used to score the bubbles marked on the grading label 40, 70, described above. The bubble scoring logic receives a grey scale image as input and a reference point, e.g., (X, Y), and outputs a score, representing the intensity of pixel darkness, for each bubble that has been marked. The bubble scores can then be utilized in conjunction with the logic shown in FIG. 16, described above, in order to determine which bubbles are marked. The marked bubbles can then be input to an electronic gradebook as described in block 110 of FIG. 4.

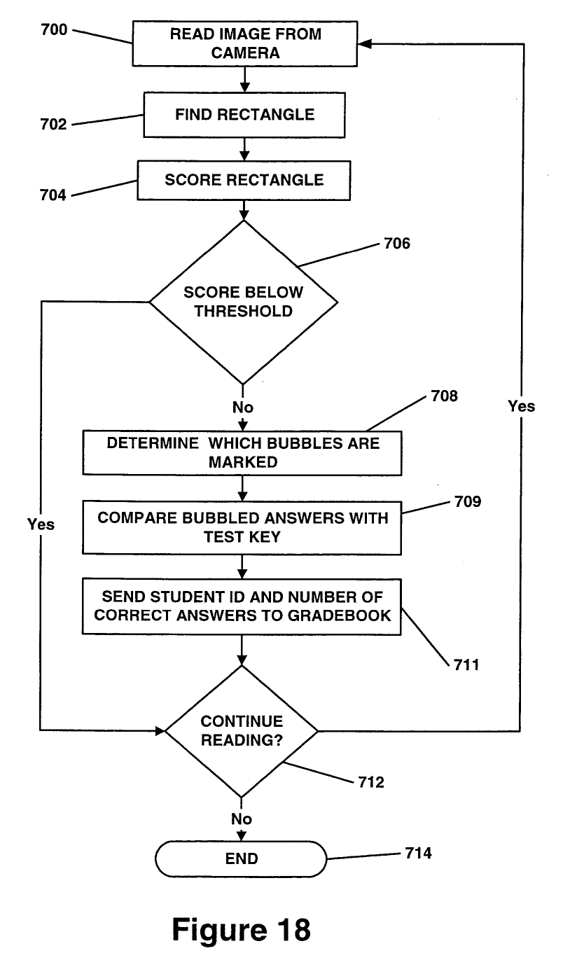

Referring now to FIG. 18, a second embodiment of the subject invention is disclosed in which student quizzes, tests, exams, term papers, etc. are graded and/or the resultant score, from a previous grading, input to an electronic gradebook. As seen in FIG. 18, the operating logic of an alternate embodiment (this second or alternate embodiment of the subject invention not only inputs student ID information, but first grades quizzes, exams, etc. and then enters a resultant score in the gradebook, additionally, either shaded bubbles or hand-written indicia may be utilized as entry means) of the present invention is shown and commences at block 700, wherein an image is read from camera 12. At block 702 (see FIG. 4 for an analogous flow diagram, without the grading, but including student ID and score input), a data rectangle, representing the outer border of the grading/data label (for grading purposes at least a portion of the grading/data label includes a plurality of answer regions that comprise either bubbles or boxed regions for recording hand-written indicia), is preferably found using the logic previously described in conjunction with FIG. 5 through FIG. 14. Moving to block 704, the rectangle is scored, as described in detail above in conjunction with FIG. 15. It is to be understood that the scoring process is used to determine the intensity of darkness of what is potentially the outer perimeter of the data rectangle. Next, at decision diamond 706, it is determined whether the score is below a threshold value. If not, the logic proceeds to block 708 where it is determined which bubbles or boxed regions are marked. In a preferred embodiment, that determination is undertaken using the marked bubble or boxed region determining logic shown in FIG. 16, again described above. Proceeding to block 709, the read values of the bubbles or boxed regions corresponding to the student identification information are established as the student identification number. In block 709, for grading, the read values of the bubbles or boxed regions corresponding to the student answer information is compared to a supplied answer key, and the number of correct answers is established as a score. At block 711, the student identification number in conjunction with the established score is sent to the electronic gradebook using any method of interprocess communication (IPC), well known in the art. Next, at decision diamond 712, it is determined whether to continue reading images from the camera 12. If not, the logic ends at state 714. If so, the logic returns to 700 and another image is read from camera 12. Returning to decision diamond 706, if the score is below the predetermined threshold, the logic proceeds to decision diamond 712. The logic then continues as described above. Accordingly, data corresponding to marked bubbles or boxed regions within the data rectangle can be automatically input to the electronic gradebook.

Further embodiments of grading/data labels 800, 900, and 1000, with each having an appropriate data field, are illustrated in FIGS. 19-21, respectively. FIG. 19 shows a third exemplary grading/data label 800. As shown, the grading/data label 800 can include an ID number input area 802 and an answer input area 804. The ID number input area 802 includes a first row of numbered input bubbles 806, a second row of numbered input bubbles 808, and a third row numbered input bubbles 810. Each row of numbered input bubbles 806, 808, and 810 can include ten individual bubbles that are individually and non-repeatingly numbered from zero (0) to nine (9). As shown, the first row of numbered input bubbles 806 can be used to record the first digit of a three digit identification (ID) number, i.e., the digit in the hundreds place. Further, the second row of numbered input bubbles 808 can be used to record the second digit of a three digit ID number, i.e., the digit in the tens place. The third row of numbered input bubbles 810 can be used to record the third digit of a three digit ID number, i.e., the digit in the ones place. Accordingly, a student's three digit ID number can be recorded within the ID number input area 802 of the grading/data label 800. As shown in FIG. 19, the answer input area 804 can be comprised of a plurality of rows, for example and not by way of limitation, 20 rows of lettered input bubbles 812. FIG. 19 shows that each row of lettered input bubbles 812 within the answer input area 804 of the grading/data label 800 can include a plurality of individual bubble, for example and not by way of limitation, four individual bubbles that may be individually labeled A, B, C, and D. As shown, each row of lettered input bubbles 812 can be used to represent one of four answers to a question. Accordingly, a student's response to a multitude of questions can be recorded with answer input area 804 of the grading/data label 800.

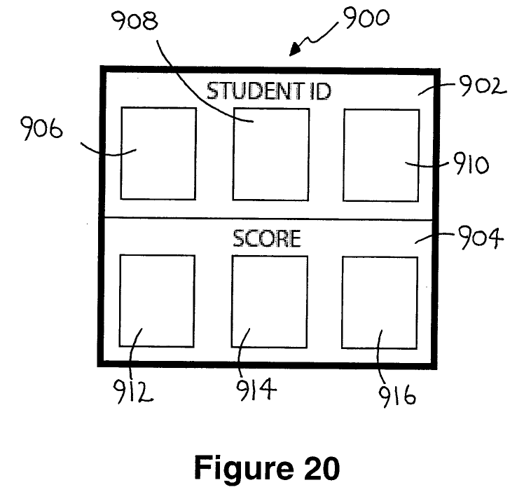

FIG. 20 shows a fourth exemplary grading/data label 900 that is utilized for hand-written indicia. As shown, the grading label 900 can include a student identification number input area 902 and a score input area 904. The student identification number input area 902 can include a plurality of bounding rectangles or boxed regions, for example and not by way of limitation the boxed regions may total three and are designated 906, 908, and 910. It is to be understood that each bounding rectangle or boxed region represents an area in which one numeral or other appropriate symbol can be hand-written. As shown, the first bounding rectangle/boxed region 906 can be used to record the first digit of a three digit identification (ID) number, i.e., the digit in the hundreds place. Further, the second bounding rectangle/boxed region 908 can be used to record the second digit of a three digit ID number, i.e., the digit in the tens place. The third bounding rectangle/boxed region 910 can be used to record the third digit of a three digit ID number, i.e., the digit in the ones place. Accordingly, a student's three digit ID number can be recorded within the ID number input area 902 of the grading label N.

As shown in FIG. 20, the score input area 904 of the grading/data label 900 can include three bounding rectangles/boxed regions 912, 914, and 916. As shown, the first bounding rectangle/boxed region 912 can be used to record the first digit of a three digit score, i.e., the digit in the hundreds place. Further, the second bounding rectangle/boxed region 914 can be used to record the second digit of a three digit score, i.e., the digit in the tens place. The third bounding rectangle/boxed region 916 can be used to record the third digit of a three digit score, i.e., the digit in the ones place. Accordingly, a student's score on an exam, test, quiz, paper, homework assignment, etc. can be recorded within the score input area 904 of the grading/data label 900. It is to be understood that in this case the score can be from zero (0) to nine-hundred ninety-nine (999), but smaller or larger scoring arrays are considered within the scope of this disclosure.

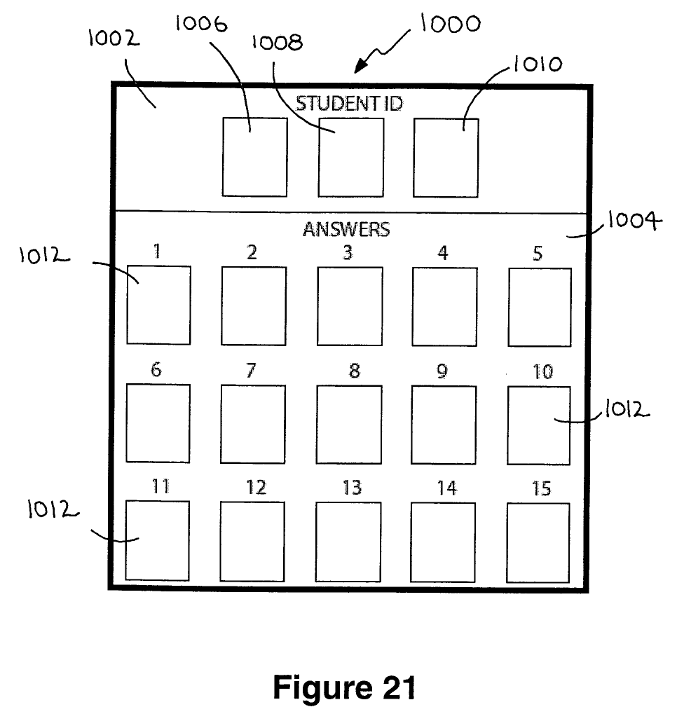

FIG. 21 shows a fifth exemplary grading/data label 1000. As shown, the grading/data label 1000 can include a student identification number input area 1002 and an answer input area 1004. It is to be understood that each bounding rectangle/boxed region represents an area in which one numeral or other suitable symbol or indicia can be hand-written. As shown, the first bounding rectangle/boxed region 1006 can be used to record the first digit of a three digit identification (ID) number, i.e., the digit in the hundreds place. Further, the second bounding rectangle/boxed region 1008 can be used to record the second digit of a three digit ID number, i.e., the digit in the tens place. The third bounding rectangle/boxed region 1010 can be used to record the third digit of a three digit ID number, i.e., the digit in the ones place. Accordingly, a student's three digit ID number can be recorded within the ID number input area 1002 of the grading/data label 1000 and it is once again noted that smaller and larger numbers may be employed with similar procedures.

As shown in FIG. 21, the answer input area 1004 can be comprised of a plurality of bounding rectangles/boxed regions, specifically and for exemplary purposes only, 15 bounding rectangles/boxed regions 1012 are shown in FIG. 21. Each bounding rectangle/boxed region 1012 represents an area in which one letter or suitable symbol/indicia may be recorded. Each letter/indicia represents one multiple choice answer. Accordingly, a student's response to a multitude of questions can be recorded with answer input area 1004 of the grading/data label 1000.

Accordingly, it can be seen that this invention provides an easy and convenient for an educator to automatically grade and/or input student ID numbers and scores from a grading/data label affixed to a quiz, test, exam, term paper, etc, to an electronic grade book. Although the description above contains many specificities, these should not be construed as limiting the scope of the invention but as merely providing illustrations of some of the presently preferred embodiments of this invention. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. A system for automatically inputting grades into an electronic gradebook, comprising:
a) a grading label comprising a data field containing data, wherein said data includes grade information and student identification information, wherein said grading label comprises:
i) an identification number input area, wherein said identification number input area is selected from a group consisting of a set of input bubbles and a set of boxed regions for hand-written indicia and
ii) a grade input area, wherein said grade input area is selected from a group consisting of a set of input bubbles and a set of boxed regions for hand-written indicia and
b) means for imaging said data field and transferring data from said data field to an electronic gradebook.

2. A system as recited in claim 1, wherein said data field comprises a data rectangle.

3. A system as recited in claim 1, wherein said data field resides on a document.

4. A system as recited in claim 1, wherein said means comprises:
a) a digital camera;
b) a microprocessor connected to said digital camera; and
c) programming associated with said microprocessor for carrying out the operations of:
i) obtaining an image of said data field,
ii) processing said data, and
iii) transferring said processed data to said electronic gradebook.

5. A system for automatically grading and inputting grades into an electronic gradebook, comprising:
a) a data field containing student identification information and grade information, wherein said grade information is selected from a group consisting of score information and answer information; and
b) means for imaging said data field and establishing and transferring a grade from said grade information and associated student identification information data from said data field to an electronic gradebook.

6. A system as recited in claim 5, wherein said data field comprises a data rectangle.

7. A system as recited in claim 5, wherein said data field resides on a document.

8. A system as recited in claim 5, wherein said means comprises:
a) a digital camera;
b) a microprocessor connected to said digital camera; and
c) programming associated with said microprocessor for carrying out the operations of:
i) obtaining an image of said data field;
ii) processing said data to establish said grade and associated student identification information data;
iii) and transferring said processed data to said electronic gradebook.

9. A system as recited in claim 5, wherein said data field comprises a grading label.

10. A system as recited in claim 5, wherein said grading label comprises:
a) an identification number input area, wherein said identification number input area is selected from a group consisting of a set of input bubbles and a set of boxed regions for hand-written indicia; and
b) a grade information input area, wherein said grade information input area is selected from a group consisting of a set of input bubbles and a set of boxed regions for hand-written indicia.

11. A system as recited in claim 10, wherein the identification number input area comprises said set of input bubbles, wherein said set of input bubbles comprises:
a) a first row of numbered input bubbles;
b) a second row of numbered input bubbles; and
c) a third row of numbered input bubbles.

12. A system as recited in claim 11, wherein each row of numbered input bubbles comprises ten input bubbles, the input bubbles being individually and non-repeatingly numbered from zero to nine.

13. A system as recited in claim 10, wherein the identification number input area comprises said set of boxed regions for hand-written indicia, wherein said set of boxed regions comprises one or more boxed regions.

14. A system as recited in claim 10, wherein said grade information input area comprises a series of lettered input bubbles.

15. A system as recited in claim 14, wherein said series of lettered input bubbles contain score information.

16. A system as recited in claim 14, wherein said series of lettered input bubbles contain answer information.

17. A system as recited in claim 10, wherein said grade information input area comprises a series of boxed regions for hand-written indicia.

18. A system as recited in claim 17, wherein said series of boxed regions contain score information.

19. A system as recited in claim 17, wherein said series of lettered input bubbles contain answer information.

20. An apparatus for automatically grading and inputting grades into an electronic gradebook, comprising:
a) a digital camera;
b) a microprocessor connected to said digital camera; and
c) programming associated with said microprocessor for carrying out the operations of:
i) obtaining an image of a data field;
ii) processing data in said data field; and
iii) transferring said processed data to said electronic gradebook.

21. An apparatus as recited in claim 20, wherein said data field comprises a data rectangle.

22. An apparatus as recited in claim 20, wherein said data field resides on a document.

23. An apparatus as recited in claim 20, wherein the data from said data field includes grade information and student identification information.

24. An apparatus as recited in claim 20, wherein said data field comprises a grading label.

25. An apparatus as recited in claim 24, wherein said grading label comprises:
a) an identification number input area, wherein said identification number input area is selected from a group consisting of a set of input bubbles and a set of boxed regions for hand-written indicia; and
b) a grade information input area, wherein said grade information input area is selected from a group consisting of a set of input bubbles and a set of boxed regions for hand-written indicia.

26. An apparatus as recited in claim 25, wherein the identification number input area comprises said set of input bubbles, wherein said set of input bubbles comprises:
a) a first row of numbered input bubbles;
b) a second row of numbered input bubbles; and
c) a third row of numbered input bubbles.

27. A system as recited in claim 26, wherein each row of numbered input bubbles comprises ten input bubbles, the input bubbles being individually and non-repeatingly numbered from zero to nine.

28. A system as recited in claim 25, wherein the identification number input area comprises said set of boxed regions for hand-written indicia, wherein said set of boxed regions comprises one or more boxed regions.

29. A system as recited in claim 25, wherein said grade information input area comprises a series of lettered input bubbles.

30. A system as recited in claim 29, wherein said series of lettered input bubbles contain score information.

31. A system as recited in claim 29, wherein said series of lettered input bubbles contain answer information.

32. A system as recited in claim 25, wherein said grade information input area comprises a series of boxed regions for hand-written indicia.

33. A system as recited in claim 32, wherein said series of boxed regions contain score information.

34. A system as recited in claim 32, wherein said series of boxed regions contain answer information.

35. A method for automatically grading and inputting data from a data rectangle to an electronic gradebook, comprising:
a) reading an image of a document having a data rectangle;
b) finding the data rectangle; and
c) inputting identification information and grade information from the data rectangle to the electronic gradebook.

36. A method as recited in claim 35, further comprising calculating a grade from said grade information and inputting said grade to the electronic gradebook.

37. A grading label, comprising:
a) an identification number input area, wherein said identification number input area is selected from a group consisting of a set of input bubbles and a set of boxed regions for hand-written indicia; and
b) a grade information input area, wherein said grade information input area is selected from a group consisting of a set of input bubbles and a set of boxed regions for hand-written indicia.
